(19) United States
(12) Patent Application Publication
(10) Pub. No.: US 2022/0042334 A1
(43) Pub. Date: Feb. 10, 2022

(54) IMPROVED COOLING APPARATUS

(71) Applicant: Thomas W RAILSBACK, Smithfield (AU)

(72) Inventor: Thomas W RAILSBACK, Smithfield (AU)

(21) Appl. No.: 17/416,530

(22) PCT Filed: Dec. 24, 2019
(86) PCT No.: PCT/AU2019/051432

§ 371 Date: Jun. 21, 2021

(30) Foreign Application Priority Data
Dec. 24, 2018 (AU) 2018904931

(51) Int. Cl. E04H 4/12; F28F 25/04; F28F 27/00

(52) U.S. Cl. CPC E04H 4/1245; F28F 2025/005; F28F 27/003; F28F 25/04

(57) ABSTRACT

The invention relates to an improved cooling apparatus for swimming pools including an inlet for water and an outlet for returning the water with a body between the inlet and outlet, with a reservoir for water contained within. A cooling arrangement associated with the body is included, the cooling arrangement able to act upon and cool the water introduced through the inlet. Further a water control apparatus, associated with the cooling arrangement is included, the water control apparatus including a high level valve and a low level valve, whereby the cooled water in the reservoir is returned through the outlet when the water level in the reservoir is above the lower level valve, and water enters the inlet only when the water level in the reservoir is below the high level valve. The invention also relates to variants thereon and methods of use.

### FIELD OF THE INVENTION

The present invention relates to an improved cooling apparatus, and in particular to an improved cooling apparatus for cooling the water of swimming pools.

### BACKGROUND OF THE INVENTION

A cooling swim in hot weather is very refreshing, and helps cool the body, due to the evaporative effect. In hot countries the water is often cool in winter but during summer the water heats in the sun and the high overnight temperature does little to cool the water. Over time and in times of extreme heat, the water in a swimming pool gradually warms until it reaches a temperature closer to blood temperature. If a person wishes to be cooled and refreshed by the dip in the pool the water must be sufficiently different and cooler when compared to the blood temperature, or it will feel tepid or even warm, which is most unpleasant. In hot countries in summer the intended cooling dip in a pool can feel more like a warming bath, most undesirable.

Therefore, it has been sought to find a way to cool the water of a swimming pool, in time of heat, to reduce the water temperature whereby the swim experience is made much more comfortable and refreshing. To go part of the way to address the problem a swimming pool cooling apparatus was disclosed in U.S. Pat. No. 7,624,589 B1 Argovitz. In the disclosed prior art invention, a hollow tower arrangement is included to evaporatively cool water taken from the swimming pool and then returned again to the body of water through use of the filter diversion system. The prior art apparatus has a cooling fan in the top, and water from the swimming pool is brought in to flow through a slowing medium, all while being cooled evaporatively by the action of the fan. Once the water is cooled it is returned to the swimming pool, via a reservoir in the bottom of the tower, whereby in continuous use the water of the body of the swimming pool is slightly cooled. A dedicated second electrical pump, is used in the prior art arrangement, a submersible pump which sits within the water reservoir. The invention of Argovitz uses this dedicated electrical pump as an essential element, however, having an electrical pump within the reservoir is clearly a safety issue. Should the water become electrified through contact of water with a live element it is likely that the whole device will be short circuited and damaged. Further, of course there is risk of electrocution if a person is in contract with the water or device at the time. Electrical devices, devices with electric and water, and devices with high risk of electrocution must be “certified” as safe before use. The device then should be regularly checked to keep the device safe and to prevent electrocution. It is more than possible that the prior art arrangements may be deemed to be in violation of AS/NZS 3000.6 safety regulations 2018. Also, submersible pumps are, by design, used and operate under extreme conditions and require strong seals to protect their integrity. These seals are a frequent point of failure, leading to failure of the pump and potential risk of short circuit or electrocution. Careful and regular checking and maintenance of these potential points of failure is essential, which increases the overall maintenance requirements for the pool, which is undesirable. These many and serious problems with the prior art, may lead to faults and inconvenience when the pool cooling fails to operate, but also the more serious, dangerous risks to safety with the potential combination of water and live electrical charge. These serious problems have led the inventor to try to develop an improved cooling apparatus, which is less likely to fault, and is safer to use.

Safety is paramount, however there are further disadvantages to the prior art system. Electrical pumps can be noisy, and required electrical power to keep them operating, which increases the running cost for cooling a pool. With the high, and every increasing cost of electric any reduction in use is highly desirable.

There is, therefore, a strong need for an improved cooling apparatus for swimming pools that does not use the second electrical pump, so that the cooling can be caused without the safety issues or high cost of the additional electric.

The subject invention has looked to address these serious problems of the prior art, and to try to improve the cooling apparatus for swimming pools, so as to remove the electrical risk. The pump for providing the water from the pool to the cooling apparatus is used to move the water, and then float valves to control the return of the cooled water. The lower and higher valves control the water flow automatically, with no further control required, and will not be altered in their action unless the outside inputs are turned off, for example. Provided the water level in the reservoir is above the lower level the cooled water will be drawn out, to return to the swimming pool. Further, the inventor has developed a simplified method that efficiently and continuously enable the cooling of the swimming pool. The improved apparatus of the subject invention is a surprisingly clever invention, that enables cooling in a more energy efficient, safe and useful manner.

The following describes non-limiting examples of the invention being used with reference to an improved cooling apparatus for cooling the water of a swimming pool. However, the improved cooling apparatus may be used in a number of useful applications. For example, a spa bath, pond or in fact any body of water that may be usefully cooled through use of the invention. It is not intended to limit the invention to use with swimming pools, other than as limited in the claims.

For clarity, any prior art referred to herein, does not constitute an admission that the prior art forms part of the common general knowledge, in Australia or elsewhere.

It is an object of the present invention to provide an improved cooling apparatus for swimming pools, that at least ameliorates one or more of the aforementioned problems of the prior art. It is a further, and separate object of the present invention to provide a method of cooling swimming pools that ameliorates one or more of the aforementioned problems of the prior art.

### DISCLOSURE OF THE INVENTION

Accordingly, the present invention provides an improved cooling apparatus for swimming pools, the apparatus including:
an inlet for water;
an outlet for returning the water;
a body between the inlet and outlet, with a reservoir for water contained within;
a cooling arrangement associated with the body, the cooling arrangement able to act upon and cool the water introduced through the inlet;
a water control apparatus, associated with the cooling arrangement, the water control apparatus including a high level valve and a low level valve, whereby the cooled water in the reservoir is returned through the outlet when the water level in the reservoir is above the lower level valve, and water enters the inlet only when the water level in the reservoir is below the high level valve,

wherein, water enters the apparatus and is substantially cooled before leaving through use of the water control apparatus and the water control apparatus provides a safer operation.

Preferably, the improved cooling apparatus does not include electrical devices in the cooling system, for improved safety. Preferably, the improved cooling apparatus provides a significantly safer cooling system for swimming pools. Preferably, the cooling apparatus uses only mechanical means to control the cooling of the water. Preferably, the cooling apparatus automatically controls the input and output of the water from the reservoir. Preferably, the cooling apparatus includes a water control apparatus that automatically maintains the water level in the reservoir between a low and high level. Preferably, the water cooling apparatus can substantially continuously cool water and return it to the swimming pool through the automatic opening and closing of the high and low level valves, thereby being an energy efficient and low maintenance means to cool the water, a significant improvement. Preferably, one or more automatic valves are included. Preferably, one or more automatic valves that can automatically open and or close are included. Most preferably, the water cooling apparatus is adapted to automatically respond. Preferably, the automatic nature of the arrangement provides a significantly improved low energy use system for cooling water.

Preferably, the apparatus is used to cool swimming pool water. The cooling apparatus may be used to cool any water, such as for a fish pond, spa bath or drinking vessel for animals. The useful valve arrangement is adaptable to a number of applications. Preferably, the invention is used with other apparatus used by a swimming pool such as to chlorinate or filter the water. The cooling apparatus can be used as part of the same pump and filter arrangement to take water out of the main body of the pool, for action before return. In other forms the invention can provide its own divert equipment to run as a standalone system separate from any cleaning or chlorination system, but this is not a preferred means as it adds costs and inconvenience to the running of the apparatus. It is an important factor of the invention that it enables the pool to be cooled without the need for additional electric use, without increasing the noise of operation, and without the need for large additional pieces of equipment. Further, as mechanical valves are used throughout the water control system the apparatus automatically operates with a low risk of failure and a low maintenance requirement, a significant improvement over the prior art.

Preferably, the inlet receives water from a swimming pool. The water may be direct from the body of water or may pass through other diversion systems first. A pump and or filter arrangement may be included between the swimming pool and the cooling apparatus. A pump and or filter system may be included in the cooling apparatus instead. The pump may be used to provide the water to the system, or to provide a suction to similarly move the water out of the system. The particular method of introducing or drawing out the water from the cooling system does not alter the method of the subject invention, and water control method.

The inlet may take any suitable form. Preferably, the inlet is in fluid communication with the water control system, before the cooled water passes to the reservoir. The inlet may itself include one or more valve, for example a one-directional valve. Water may be pumped into the system by a diversion pump of the swimming pool to introduce water into the system. The inlet and outlet may be considered part of the water control apparatus.

The outlet may take any suitable form. Preferably, the outlet is in fluid communication with the water control system, after the cooled water passes to the reservoir. The outlet may itself include one or more valve, for example a one-directional valve. The outlet may be in fluid communication with an inlet to draw water from the reservoir out of the system. Water may be drawn from the reservoir through suction to leave the water control apparatus through the outlet. The inlet and outlet may be considered part of the water control apparatus.

Preferably, water is introduced into the cooling apparatus through the inlet and may leave the reservoir through the outlet.

Preferably, the body surrounds the cooling apparatus and water return apparatus. The body may take any suitable form. The body may be substantially barrel shaped for containing the components therein. The body may be a waterproof arrangement for fully containing the components therein. Preferably, a reservoir is created in the body for water. The reservoir may be used to contain water at any stage of the process. Preferably, the cooled water is directed to a reservoir before being returned through the outlet by the water control apparatus.

The reservoir preferably is formed in the base of the body. In other forms of the invention the reservoir may be separate to the body. Preferably, the reservoir is configured to be suitably sized for cooling flow of water. The reservoir may include an underfill level. The reservoir may include an overfill level. Preferably, the reservoir is adapted to hold a suitable volume of water for operation of the cooling apparatus.

Preferably, the reservoir is in the base of the body. Preferably, the reservoir has a low level for water below which it is desired the water level should not drop. Preferably, the low water level for water is a level suitable to keep the water control means operational. Preferably, the reservoir includes a high water level, a maximum level for water to be contained within the reservoir. Preferably, the water control apparatus maintains the cooling apparatus with water levels in the reservoir between the low water level and high water level, during normal operation.

Preferably, the cooling arrangement uses evaporative cooling of the flow of water. The cooling arrangement may be of a known form including the evaporative cooling from a fan above a spray of water droplets. Preferably, the cooling arrangement includes a fan to cool the water. Preferably, the cooling arrangement includes a spray apparatus to spray the input water whereby the fan action cools the sprayed water. Preferably, media is included such as round particulates so that the slowed water has a longer time to be cooled evaporatively by the fan. Any suitable slowing mechanism may be used. Any suitable media may be used to slow the progress of the water, to be cooled.

Preferably, water is introduced through the inlet into the cooling arrangement drawn up sprayed as droplets to be cooled by the fan and slowed through the media. Preferably, the cooled water ultimately runs to the reservoir before exiting through the outlet.

Preferably, the cooling arrangement includes a fan, powered by a motor. Preferably, the fan acts on a spray of water. Preferably, the spray of water is slowed through media. Preferably, the cooling arrangement includes a fan, powered by a motor, acting on a spray of water, slowed through media, before running to a reservoir. Alternative forms of cooling arrangement may be used with the invention. The cooling arrangement may take any suitable form.

Preferably, the water control apparatus includes a means to control the water level in the cooling apparatus. Preferably, the water control apparatus includes one or more valves to assist in the control of the water. Preferably, the flow in and flow out of the water is controlled by the water control apparatus. Preferably, the water is maintained by the water control apparatus between a suitable low water level and a suitable high water level.

Preferably, the water control apparatus keeps the water flowing in and out and maintains a suitable level within the apparatus during operation and this is achieved without the need for an additional pump.

Preferably, the water control system is configured to work without additional power or controls. Preferably, the water control system is configured to work through use of mechanical controls. Preferably, the water control system is configured to work substantially automatically and continuously through use of exclusively mechanical controls. Preferably, the water control system operates without use of additional power, or controls. Preferably, the water control system operates automatically to move the water into the system and the return cooled water to the pool. The water control system preferably automatically keeps the reservoir levels between an overfill and underfill level. Preferably, the overfill level is at predetermined high level to keep the level of water at a safe level. Preferably, the underfill level is a predetermined low level below which water is not removed from the reservoir. The overfill and underfill levels may be adjusted to be suitable safe levels for the particular system.

Preferably, the high level valve only allows water in when the water in the reservoir is below the high water level. The high water level will be predetermined for safety. The high level water, when exceeded, closes the high level valve so water no longer enters, and the low water valve is open to drain water from the reservoir until the water level returns to be between the high water level and the lower water level. Preferably, the high level valve is a float valve. Preferably, the high level valve is a float valve. Preferably, the high level valve floats on the top of the water and closes the valve to prevent further water entering the system if the float valve is above the high water level.

Preferably, the high water level valve is of a kind produced by Hansen www.hansenproducts.com, known as a Max-Flo (Trade Mark) trough/tank valve. Preferably, the valve is a high performance valve. Preferably, the valve is 29 psi, 570 l/min or similar. Preferably, the valve is economic to run. Preferably, the valve is UV resistant. Preferably, the float is substantially 100 millimetres in diameter. Similar valves can be used instead.

Preferably, the low level valve only allows water to drain away when the water in the reservoir is above the low water level Therefore a water reservoir below the low water level remains at all times. The low water level will be predetermined for safety to prevent underfilling. The low level water, when there is insufficient water, closes the low level valve so water only drains away (returning water, now cooled to the swimming pool) if the low water valve is open to drain water from the reservoir. If the high level valve is closed water will continue to drain away until the water in reservoir is returned to a level below the high water level to prevent overfilling.

Preferably, the low level valve is a float valve. Preferably, the low level valve is a float valve as illustrated in FIGS. 6 to 11. Preferably, the low level valve includes a float, that floats in the water and if above the predetermined lower level is open to allow water to drain.

Preferably, the high level valve and low level valve are both float valves and the predetermined levels determine the fill and drain of the reservoir.

The high valve level may be omitted in an inferior form of the invention. The high valve level may be replaced with alternative means to prevent overfilling in an alternative form of the invention.

Preferably, the low level valve is a new form of valve. Preferably, the low level valve includes a sleeve section. Preferably, the sleeve section can fit about the low level pipe. Multiple valves may be included, including valves of different kinds or forms. Most preferably, a single valve is included, forms of a plurality of sleeve sections to create a valve section on low level pipe.

Preferably, a plurality of sleeve sections are included which interlock in order to create a sleeve section of a variable length. Preferably, 3 or more sleeve sections are used to create a single sleeve. The interlocking may be through a lock and key arrangement. The interlocking may be through use of one or more cut-out on one section and one or more corresponding projection. The cut-outs may be square and a square projection may fit therein. Preferably, once the sections are interlocked a single sleeve is created to fit about a pipe. Preferably, the sleeve can rotate about the pipe.

Preferably, one or more float is attached to the sleeve to operate the valve. Preferably, the float valve moves up and down with the level of the water and the movement rotates the sleeve about the pipe.

Preferably, one or more holes are formed in the low level pipe. Preferably, the sleeve includes corresponding holes. Preferably, the movement of the float in response to the changes in water level causes rotation of the sleeve to open or close the holes over the pipe holes. Preferably, water can flow out of the outlet pipe when the valve is open, and the holes uncovered. When covered, due to the dropping of the float valve level, the water is prevented from entering the outlet. Preferably, an intermediate state where the holes are partially open and partially allow some outflow is also possible.

The holes in the pipe may be any suitable shape. Preferably, a plurality of circular holes are included in the pipe. Preferably, the corresponding holes in the sleeve are of a similar size and shape. Lips maybe included for the holes to strengthen the holes and to assist the flow of water.

Preferably, one or more inner supports may be included to provide a support to the rotation of the sleeve. These supports may be periodic along the inner length.

Accordingly, the invention provides, in a variant, an improved cooling apparatus for use with diversions for swimming pools including a cooling system, the apparatus including:
an inlet for providing water;
an outlet for returning the water;
a body between the inlet and outlet, with a reservoir for water contained within;
a water control apparatus including a high level valve, and a lower level valve, whereby water from the reservoir is returned when the water level in the reservoir is above the lower level valve, and enters the system when the water level is above the high level valve.

Accordingly, the invention provides in a variant, an improved cooling apparatus and swimming pool, the apparatus including:
a swimming pool in fluid communication with the cooling apparatus;
an inlet for providing water from the swimming pool to the cooling apparatus;
an outlet for returning the water from the cooling apparatus to the swimming pool;
a body between the inlet and outlet, with a reservoir for water contained within;
a cooling arrangement associated with the body, the cooling arrangement able to act on the water introduced through the inlet from to cause cooling;
a water control apparatus, associated with the cooling apparatus, the water control apparatus including a high level valve, and a lower level valve, whereby the cooled water reservoir is returned to the swimming pool when the water level in the reservoir is above the lower level valve, and enters the system when the water level is above the high level valve,

wherein, water cooling occurs during operation of the apparatus and water is returned to the swimming pool through use of the water control apparatus and the water control apparatus provides a safer operation.

Preferably, a pump is included between the swimming pool and the cooling apparatus. Preferably, a filter is included to filter the water passing through the system. Any suitable diversion system may be used between the apparatus of the invention and the swimming pool.

Preferably, the cooling apparatus and swimming pool is the cooling apparatus of the invention in any of its forms and variants.

Accordingly, the invention provides a method of cooling water for swimming pools, using a cooling apparatus, the cooling apparatus including an inlet, outlet, and a body with a reservoir, cooling apparatus and a high water level above which the high level valve closes, and a low water level and low water valve which closes drainage when the water is below the low level, the method including the steps:
a) introducing water through the inlet of the cooling apparatus if the water in the water is below the high level and the high level valve is open;
b) cooling the water through use of the cooling arrangement;
c) returning the cooled water to the swimming pool if the water level is above the low water level and the low water valve is open,

wherein the water is cooled and the reservoir water maintained substantially between the low and high water levels.

The apparatus of the method may be the apparatus of the invention in any of its forms or variants.

### INDUSTRIAL APPLICABILITY

The apparatus can be manufactured industrially and provided to swimming pool wholesale or retailers. The apparatus in some forms may be offered directly to consumers as a retrofit.

It will be apparent to a person skilled in the art that changes may be made to the embodiments disclosed herein without departing from the spirit and scope of the invention in its various aspects.

### BRIEF DESCRIPTION OF THE DRAWINGS

The invention will now be described in connection with non-limiting preferred embodiments with reference to the accompanying drawings, in which:

FIG. 1 is a front diagrammatic view of a cooling apparatus for a swimming pool according to a first preferred embodiment of the invention, the swimming pool is omitted for ease of illustration;

FIG. 2 is a component diagram illustrating the pump and filter components of the system of FIG. 1, showing how the cooled water is to be returned;

FIG. 3 is a further component diagram illustrating the water return apparatus of the invention of FIGS. 1 and 2;

FIG. 4 is a detailed diagram of the Flowjack (TRADE MARK) valve as used in the embodiment of FIGS. 1 to 3; and

FIG. 5 is a detailed diagram of the Flowjack (TRADE MARK) valve as used in the embodiment of FIGS. 1 to 3;

FIG. 6 is a perspective view of a low level valve according to a second preferred embodiment of the invention, the remainder of the cooling apparatus and the pool are omitted for ease of illustration;

FIG. 7 is a perspective front view of the low level valve sleeve of the low level valve of FIG. 6, with the remaining components omitted, and cross-sectional line AB indicated;

FIG. 8 is a cross-sectional view through AB of the low level valve sleeve of FIG. 7;

FIG. 9 is an end view of the low level valve sleeve of the low level valve of FIGS. 6 and 7, in the open position;

FIG. 10 is an end view of the low level valve sleeve of the low level valve of FIGS. 6 and 7, in the closed position; and

FIG. 11 is a plan view from below of the low level valve sleeve of the low level valve of FIGS. 6 and 7.

### DETAILED DESCRIPTION OF THE INVENTION INCLUDING A BEST MODE

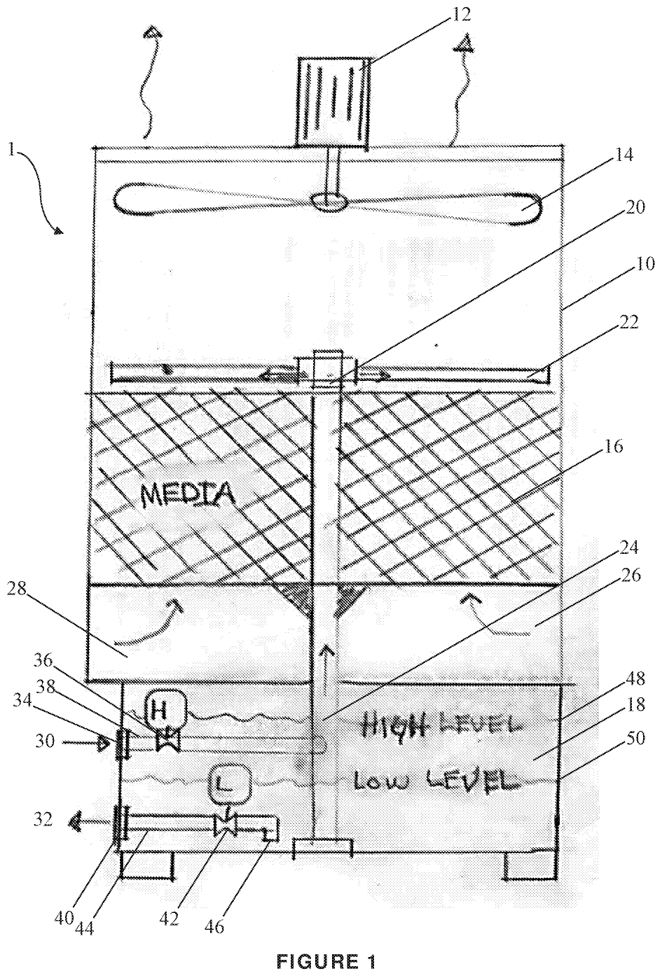

Referring to FIGS. 1 to 4, a first preferred embodiment of the invention will be described, where cooling apparatus 1, has body 10, with motor 12 to power fan 14, and these components are similar to the prior art. Motor 12 is powered to cause fan 14 to turn to create the evaporative cooling, with the air flow indicated by the upwards pointing arrows. To slow the fall of water droplets, media 16 is used as can be seen in the central portion of body 10, with reservoir 18 seen in the base of body 10. Water drawn in water system 20 is sprayed through spray system 22, whereby the spray droplets are cooled by the air flow and fan. Water system 20 includes pipe 24 which passes through air flow areas 26 and 28.

Turning to the water return system itself (not separately labelled) this commences at inlet 30 which brings water from the pool (not shown) into the system for cooling, through inlet valve 34. The water levels in the reservoir 18, it should be pointed out, are important inlet 30 leads through inlet valve 34 to high level valve 36 on pipe 38. High level valve 36 leads to pipe 24 to take the water up to be sprayed through spray system 22 to be evaporatively cooled by the fan action (14). The high level part of the water cooling system is positioned below but close to the high level water point. Similarly, arranged close to a low water level point, above which the water is intended to be kept, water outlet 40 can be seen leading to low level valve 42. Between outlet 40 and low level valve 42 is low level pipe 40 with inlet valve 46 sitting at the low water level point. The positioning is important so that water is only drawn through inlet valve 46 from the cooled reservoir if there is water above the opening. Therefore, if insufficient cooled water is in the reservoir no further water will be removed through the outlet from the reservoir until the water level raises.

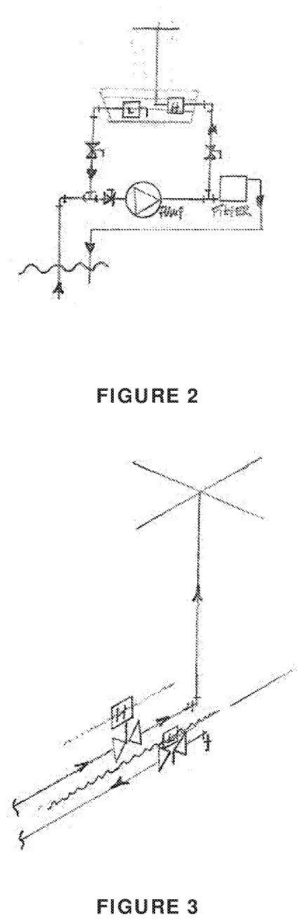

FIG. 2 illustrate the components in addition to the water cooling of the system. For example, including the pump and filter in relation to the pool water itself for the water removed or returned cooled to the pool. FIG. 3 diagrammatically shows the components of the high and low level components of the water control system, important for the invention.

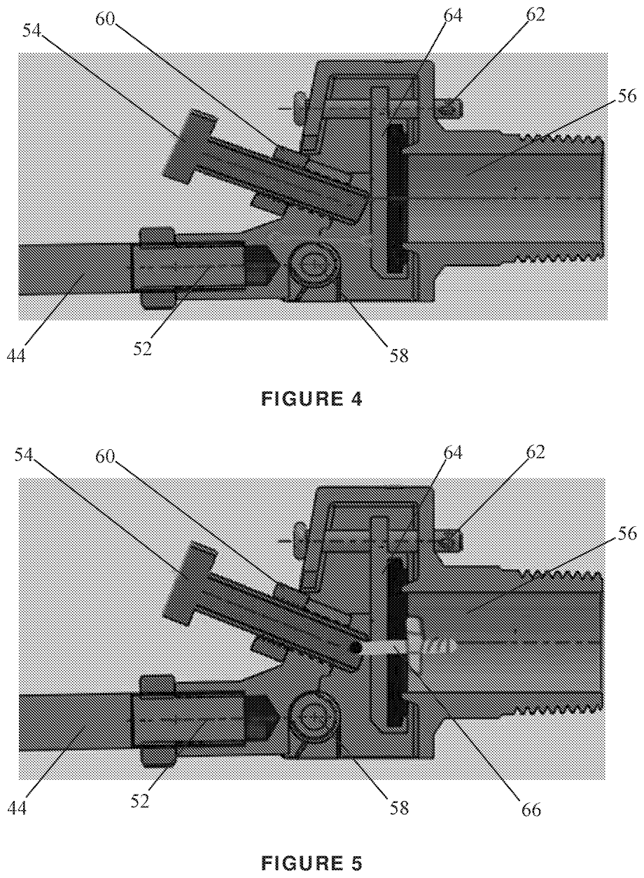

FIG. 4 illustrates a FLOWJACK (Trade Mark) valve as will be used for both the high and low level valves in the first preferred embodiment (see the new valves used in the second embodiment, as detailed separately below) in the appropriate direction with parts labelled 44 to 64. The valve is of the kind as used in livestock watering systems, but utilised in the disclosed invention to control the flow. It is important that the reservoir is kept with an appropriate fill of water, and does not over or under fill. It is anticipated that the particular form of the valves may evolve during the coming months of development. As the float valve moves to the predetermined level the valve opens or closes to allow or prevent the flow of water.

During use cooling apparatus 1, reservoir 18 will have a water level below the lower level 50 and below inlet 46, in that all the cooled water has been returned. As water enters the system from the swimming pool through inlet 30 the water is drawn into spray system 22 up pipe 24. As the droplets are sprayed out onto media 16 action of fan 14 dramatically cools the water, before it falls to reservoir 18. After some operation the level of water raises above the level of inlet 46 whereby water can be drawn out for return to the swimming pool. If the level of water is below the high level valve 36, the water will continue to enter the system until the high level is reached. Float valves are used for valves 36 and 42 so that these act only between set predetermined water levels. Float valves 36 and 42 of the first embodiment, are similar to those used in livestock or irrigation watering systems. Outside pump action will provide the suction to the system to keep the water circulating (refer FIG. 2). Float valve 36 is useful as when it reaches the predetermined overflow level, the high level it stops further water entering the system, to prevent overfilling.

The low level valve 42 will keep open to allow water drawn up through Flowjack (TRADE MARK) valve (FIG. 4) to flow for as long as the valve is open. Water will therefore leave the system and then as the water level lowers, the high level valve will open once again below the high level. As the high level valve opens, water again starts to enter the system from the pool, for cooling, and the operation continues to cool the water.

The safety of the operation is absolute, the system cannot overfill as the float valve will prevent filling beyond the high water level. Similar, the reservoir will be filled until the high level and drain the cool water back only if there is water to be drained above the high level in reservoir 18. The automated system is safe, reliable, has few working parts, can easily be checked and maintained but should run without maintenance for a prolonged period with no risk of failure. Should a problem arise in either the high or low level valves, the other one will either prevent further water entering the system or drain the system to remove the excess water, creating a strongly safe system. Unlike the prior art there is no need for extra electric to power an extra pump and there is no need for safety measures to isolate electrical parts from the water for safety. Instead the parts work mechanically to open and close in response to suction pressure and the level of the water and so will continue to work, without the need for further controls or power.

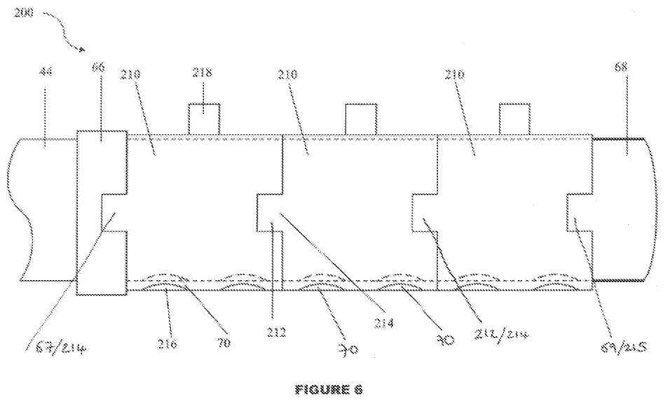

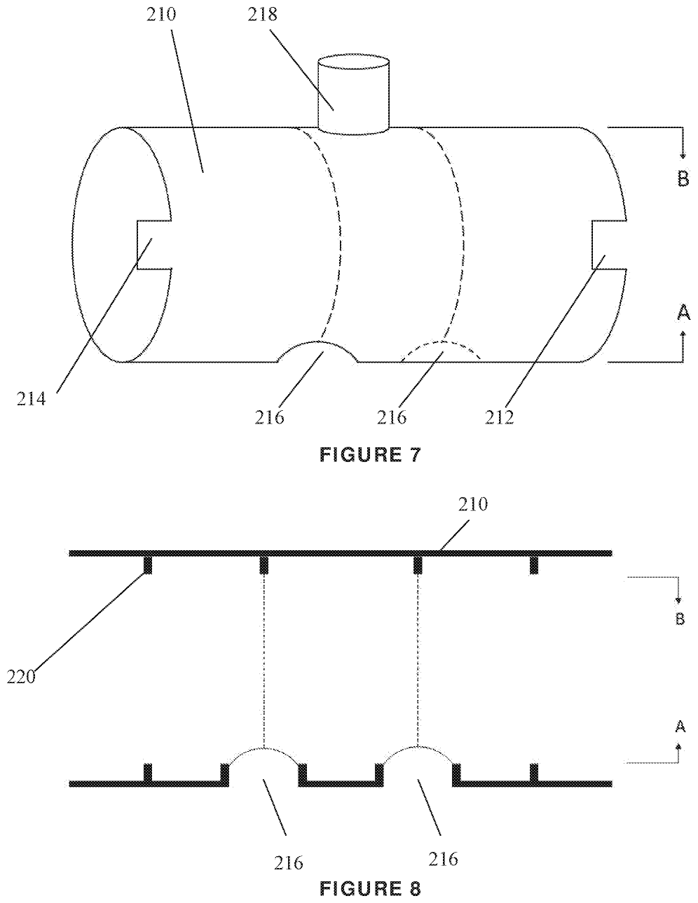

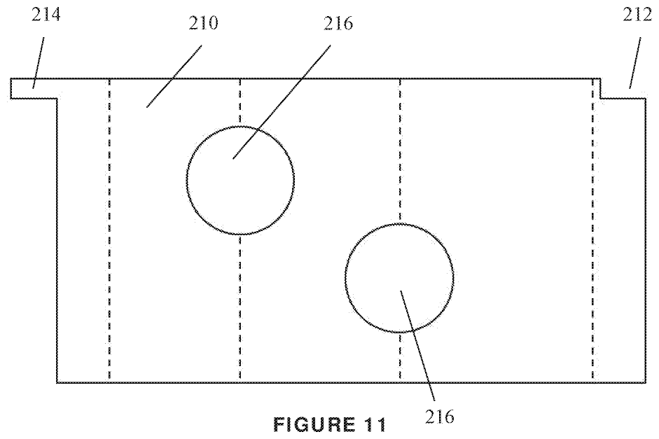

Referring to FIGS. 6 to 11, a second preferred embodiment of the invention will be described the same as the first, excepting that the low level valve of the first embodiment, has been replaced with a new valve designed by the inventor, and the high level valve is a Hansen (Trade Mark) MAX-Flo (Trade Mark) trough or tank valve. These float valves work with similar principles, but in a preferred format for use of the subject invention, different to the first preferred embodiment. The remainder of the invention of the second embodiment is as described for the first embodiments.

The replaced low water valve will now be described (the replacement for low water valve 42 of FIG. 1) fitted about low pipe 44 of the cooling apparatus, equivalent to cooling apparatus 1 of FIG. 1. Collar 66, including cut-out 67 holds the valve in position on collar 66 as cut-out 67 receives part of the valve as described below. Cap 68 provides an end cap 68 to low pipe 44, and projection 69 of the valve is adapted to receive a projection (215 see below), which further maintains connection with the valve sleeve. Instead of outlet 46, a number of holes 70 (only some of which are labelled) will provide the inlets for low pipe 44, when the valve is in an open state, to enable the water to flow to the outlet to the pool. Low level valve 200, connected around low pipe 44 includes 3 low level valve sleeves 210, each interconnected. Each valve sleeve section 210 is the same and multiple units can be used to create a longer or shorter valve section as may be required for a particular application. Each valve sleeve section 210 includes cut-outs 212, which corresponds to projections 214, which fit together so each sleeve section 210 becomes a single sleeve, which can be rotated together. In the same way projection 215 fits in cut-out 69 of end cap 68, as can be seen in FIG. 6. Although shown as square cut-outs, as a convenient shape to fit square projections therewithin, the shape may be varied in other forms of the invention.

Holes 216 in valve sleeve sections 210 can be aligned with holes 70 of pipe 44 to create an open state for flow in of water. In the open state the water will flow into holes 70, however when closed the water is prevented from flowing in and so is maintained from flowing away. When a float (not illustrated) attached to float attachment 218 ascends with the rising water level, valve sleeve section 210 rotate about pipe 44, holes 216 are also turned to align with holes 70 of pipe 44. Float attachment 218 extends at 90 degrees to the body of valve sleeve 210 to enable free extension to the float and unfettered rotation of valve sleeve section 210.

The extent of alignment of holes 70 and holes 216 further determines the rate of water flow into low pipe 44 so as to a control the outflow of water from the cooling apparatus. In the most part this is open to allow the flow into pipe 44 and out of the outlet, and inflow being prevented when closed. However, a partially open state is possible when the float only partially rotates the sleeve, whereby a slow flow of water is allowed in through the partially open holes 70, to flow to the outlet. It may be considered that there is an open, intermediate and closed state for valve 200, to enable flow out at full rate, partial rate or substantially no rate. In the closed state some small flow may be tolerated in some forms of the invention.

Internal supports 220 (refer FIG. 8) are included periodically, on the inside walls of valve sleeve units 210 assist to keep valve sleeve sections 210 centred with pipe 44 during rotation. Further internal lips (not labelled) about the holes of the sleeve, facilitates sealing in between holes 70 of pipe 44, and holes 216 of valve sleeve 210 when closed, to prevent water leaking.

Low level pipe 44 as described is a standard polyvinyl chloride (PVC). In alternative forms of the invention a similar pipe made of other suitable materials, such as metal or engineered materials. As illustrated valve sleeve 210 has an internal diameter very similar to the outer diameter of pipe 44, with minor tolerance as would be understood by the person skilled in the art.

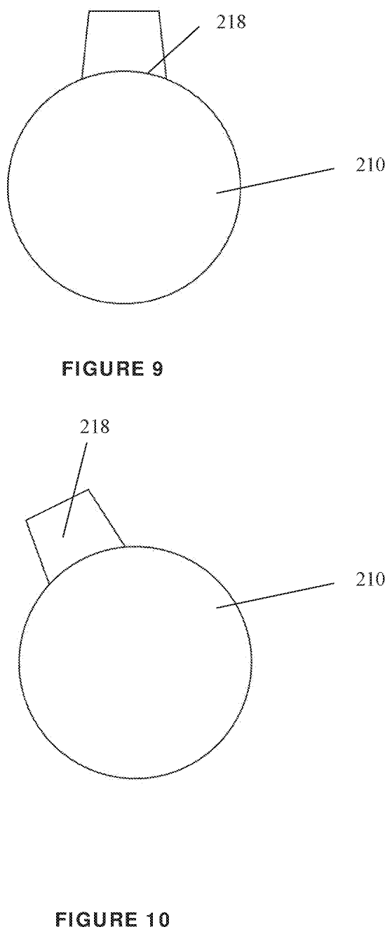

As shown in FIGS. 9 and 10, sleeves 210, with two different positions of the float can be seen. Movement of the float in response to the changing water level would changing the position of float attachment 218 and rotates the sleeve position and so the relative open or closed state of holes 216. The float attachment used is a of a standard form as used with float valves in the field.

Clearly, the subject invention provides a significant advance over the prior art, working automatically to cool, without the need for an electric pump. The resultant apparatus is not only economic to run, it is safer, will run smoothly with minimal maintenance. The inventor has developed an improved cooling system which provides a significant improvement, and is likely to be very well received by the consuming public, once known.

### REFERENCE SIGNS LIST

| | |
|---|---|
| 1 | Cooling apparatus |
| 10 | Body |
| 12 | Motor |
| 14 | Fan |
| 16 | Media |
| 18 | Reservoir |
| 20 | Water system |
| 22 | Spray system |
| 24 | Pipe |
| 26 | Airflow |
| 28 | Airflow |
| 30 | Inlet from pool |
| 32 | Outlet to pool |
| 34 | Inlet valve |
| 36 | High level valve |
| 38 | High level pipe |
| 40 | Outlet valve |
| 42 | Low level valve |
| 44 | Low pipe |
| 46 | Low level outlet |
| 48 | High water level |
| 50 | Low water level |
| 52-64 | Flowjack valve |
| 66 | Collar |
| 67 | Cut-out |
| 69 | Cut-out |
| 70 | Holes |
| 200 | Low level valve |
| 210 | Low level valve sleeve |
| 212 | Cut-out |
| 214 | Projection |
| 215 | Projection |
| 216 | Holes |
| 218 | Float attachment |
| 220 | Internal supports |

1-48. (canceled)

49. An improved cooling apparatus for swimming pools, the apparatus including:
an inlet for water;
an outlet for returning the water;
a body between the inlet and outlet, with a reservoir for water contained within;
a cooling arrangement associated with the body, the cooling arrangement able to act upon and cool the water introduced through the inlet;
a water control apparatus, associated with the cooling arrangement, the water control apparatus including a high level valve and a low level valve, whereby the cooled water in the reservoir is returned through the outlet when the water level in the reservoir is above the lower level valve, and water enters the inlet only when the water level in the reservoir is below the high level valve,
wherein, water enters the apparatus and is substantially cooled before leaving through use of the water control apparatus and the water control apparatus provides a safer operation.

50. The improved cooling apparatus of claim 49, wherein the cooling apparatus includes a water control apparatus that automatically maintains the water level in the reservoir between a low and high level and can substantially continuously cool water and return it to the swimming pool through the automatic opening and closing of the high and low level valves, thereby being an energy efficient and low maintenance means to cool the water.

51. The improved cooling apparatus claim 49, wherein one or more automatic valves are included.

52. The improved cooling apparatus of claim 1, wherein water is introduced into the cooling apparatus through the inlet, cooled and cooled water directed to the reservoir and leaves the reservoir through the outlet.

53. The improved cooling apparatus of claim 1, wherein the water control apparatus maintains the cooling apparatus with water levels in the reservoir between a low water level and a high water level, during normal operation.

54. The improved cooling apparatus of claim 1, wherein the cooling arrangement uses evaporative cooling of the flow of water.

55. The improved cooling apparatus of claim 1, wherein the cooling arrangement includes a fan and a spray apparatus to spray the input water whereby the fan action cools the sprayed water.

56. The improved cooling apparatus of claim 1, wherein the water control apparatus includes one or more valves to assist in the control of the water and the flow in and flow out of the water is controlled by the water control apparatus.

57. The improved cooling apparatus of claim 1, wherein the water is maintained by the water control apparatus between a suitable low water level and a suitable high water level and further wherein the water control apparatus keeps the water flowing in and out and maintains a suitable level within the apparatus during operation and this is achieved without the need for an additional pump.

58. The improved cooling apparatus of claim 1, wherein the water control system is configured to work substantially automatically and continuously through use of exclusively mechanical controls.

59. The improved cooling apparatus of claim 1, wherein the water control system automatically keeps the reservoir levels between an overfill and underfill level and the overfill level is at predetermined high level to keep the level of water at a safe level and the underfill level is a predetermined low level below which water is not removed from the reservoir.

60. The improved cooling apparatus of claim 1, wherein the high level valve only allows water in when the water in the reservoir is below the high water level and when exceeded, closes the high level valve so water no longer enters, and the low water valve is open to drain water from the reservoir until the water level returns to be between the high water level and the lower water level.

61. The improved cooling apparatus of claim 1, wherein the high level valve and or the low level valve is a float valve and the high level valve floats on the top of the water and closes the valve to prevent further water entering the system if the float valve is above the high water level.

62. The improved cooling apparatus of claim 1, wherein the low level valve only allows water to drain away when the water in the reservoir is above the low water level and is open to drain water from the reservoir.

63. The improved cooling apparatus of claim 1, wherein the low level valve includes a sleeve section and is a single valve formed of one or more sleeve sections and the sleeve sections can fit about the low level pipe to create a valve section on the low level pipe.

64. The improved cooling apparatus of claim 63, wherein a plurality of sleeve sections are included which interlock in order to create a sleeve section of a variable length.

65. The improved cooling apparatus of claim 63, wherein the sleeve section can rotate about the pipe.

66. The improved cooling apparatus of claim 63, wherein one or more floats is attached to the sleeve to operate the valve, as the float valve moves up and down with the level of the water and the movement rotates the sleeve about the pipe.

67. The improved cooling apparatus of claim 63, wherein one or more holes are formed in the low level pipe and the sleeve includes corresponding holes and the movement of the float in response to the changes in water level causes rotation of the sleeve to open or close the holes over the pipe holes and water can flow out of the outlet pipe when the valve is open, and the holes uncovered and water is prevented from leaving when covered, due to the dropping of the float valve level, so the water is prevented from entering the outlet.

68. A method of cooling water for swimming pools, using the cooling apparatus of claim 1, the method including the steps:
a) introducing water through the inlet of the cooling apparatus if the water in the water is below the high level and the high level valve is open;
b) cooling the water through use of the cooling arrangement;
c) returning the cooled water to the swimming pool if the water level is above the low water level and the low water valve is open,
wherein the water is cooled and the reservoir water maintained substantially between the low and high water levels.
